(19) United States
(12) Patent Application Publication
(10) Pub. No.: US 2025/0123829 A1
(43) Pub. Date: Apr. 17, 2025

(54) EXPEDITED UPDATE FRAMEWORK

(71) Applicant: Omnissa, LLC, Mountain View, CA (US)

(72) Inventors: Grischa Ernst, Koeln (DE); Joshua Burris, Atlanta, GA (US); Shubham Choudhary, Atlanta, GA (US)

(21) Appl. No.: 18/488,080

(22) Filed: Oct. 17, 2023

(51) Int. Cl. G06F 8/65

(52) U.S. Cl. CPC G06F 8/65

(57) ABSTRACT

Disclosed are various approaches for providing an expediated update framework. Update data is retrieved for a product update provided by an update catalog network service. An update package is generated to automatically deploy the product update within a specified time from a release date of the product update. A smart group dynamically selects a subset of a plurality of client devices. The specified subset corresponds to the update data for the product update. The update package is deployed to the subset of the client devices using the smart group.

### BACKGROUND

In enterprise environments, operating system and other software updates can be a common but important occurrence. These updates can provide utility and value to an enterprise in various manners. For example, updates can provide security enhancements. With the constantly evolving landscape of cyber threats, updates can address known and potential vulnerabilities. Neglecting these updates can leave systems exposed to cyberattacks, data breaches, and other security risks, endangering enterprise information and productivity. Updates can also provides bug fixes and stability improvements that can affect system stability and performance. Feature enhancements, cost savings, business continuity, and competitive advantage underscore the significance of operating system and other software updates

Management services can include unified endpoint management (UEM), mobile device management (MDM), virtualization services, and other services. MDM services can manage and secure mobile devices that are used for enterprise productivity. UEM services can manage access to enterprise resources through a broad range of endpoints such as websites, desktops, mobile devices, and virtual devices, among others. Management services can provide Software as a Service, Infrastructure as a Service, Platform as a Service, and other types of services that can include operating systems and software that is subject to regular updates that are provided by the developer or other provider of these items. Some updates can be subject to automatic update systems, and others can be limited to manual updates or patches from provider or third party knowledge base articles.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a block diagram of a networked environment that includes components that implement an expedited update framework, according to various examples of the disclosure.

FIG. 2 is a flowchart that illustrates functionality implemented using components of the networked environment, according to an example of the disclosure.

FIG. 3 is another flowchart that illustrates functionality implemented using components of the networked environment, according to an example of the disclosure.

FIG. 4 is a drawing that illustrates functionality implemented using components of the networked environment, according to an example of the disclosure.

### DETAILED DESCRIPTION

Disclosed are examples of an expedited update framework implemented using a management service and provides operating systems and other software. The management service can provide operating system and software updates for the various devices and service features that are managed in association with an enterprise. The updates can be developed by a software developer or other provider of the operating system or other software suite. In some examples, the developer can provide an automatic update system integrated with the operating system or software suite. However, the updates can additionally or alternatively include patches and configurations that are posted to a network hosted knowledge base, whether or not the update is developed by the software developer or a third party, and whether or not the update is also provided through an automatic update system. Manual updates from knowledge bases can be difficult to apply in a timely fashion, and automatic update systems can often include delays of days or weeks based on settings of individual devices and server-side rules of the developer's update system. However, the present disclosure provides mechanisms that enable a management service to ensure that all of an enterprise's devices and services are updated within a specific expedited timeframe relative to developer-provided update systems and manual updates.

For example, the mechanisms described herein enable an enterprise administrator to deploy any update for operating systems and software suites. The management service can include a console that can query an update catalog to obtain article data and update data using application programming interface commands. The update can be configured and packaged for deployment using a microservice that can apply the updates. The application framework can be used to push the update to various devices. The update application will not show in the application list view.

Reboot behavior can be selected and defined for the generated update application based on the update information retrieved from the update catalog. For example, certain keywords, types of updates, architectures, and other update data can be mapped to a specific reboot behavior. For example, some updates can allow user-engaged restart with a forced restart after a predetermined time specified in days, hours, or another unit of time. Other updates can omit a forced restart, and yet further updates can force a restart immediately after the update is applied.

The name or identifier of the update application is the update title retrieved from the update catalog or knowledge base. In some examples, the update catalog and the knowledge base are both part of a single network service provided by a single developer or product provider. In other examples, the update catalog and the knowledge base can be separate network services whether the services are provided by a single entity or different entities. A detection method can check if the update is installed and return an update installation status such as installed, not installed, in progress, not in progress, and so on. An agent or the update application can maintain a separate log for update installation monitoring, which can be maintained on each device that executes one or more of the update applications. Event logging for the device can be provided and maintained in the server-side console user interface of the management service. Update deployment can be automatically stopped after a predetermined amount of time, such as 30 days or another timeline, in order to prevent errors on devices. In some examples, an update or update application can indicate that it supersedes one or more specified updates (or applications). In that example, the deployment of the superseding update application can automatically cause removal of the superseded update applications. In some situations, a setting can indicate a maximum number of updates, such as ten or another predetermined number, that can be deployed to a device at the same time. A setting can additionally or alternatively indicate a maximum amount of resources that update applications can consume, such that further updates are not allowed. Updates beyond the maximum number of resource amount can be queued for future deployment once another update is completed and sufficient update slots and/or resources become available.

Administratively stopped, completed, superseded, and removed deployments of update applications can be moved to an update history or deployment history maintained by the management service. This process can include deleting the update application from a content distribution network, and saving deployment statistics such as success and failure rates, total number of successful and failed installations, time from beginning to end of installation, time from deployment to all device completion (or stopping, superseding, or removal), and so on.

In this context, as one skilled in the art will appreciate in light of this disclosure, embodiments can achieve certain improvements and advantages over traditional technologies, including some or all of the following: (1) improving the functioning of computer systems and networks by increasing a speed of update deployment in individual devices; (2) improving the flexibility of computer systems and networks by superseding an update rather than performing a complete update followed by a superseding update; (3) improving the functioning of computer systems and networks, including reducing power consumption and network bandwidth usage, by enabling superseding an update rather than performing a complete update followed by a superseding update; (4) improving the functioning of computer systems and networks by increasing a speed of update deployment as a total across multiple devices; (5) improving the functioning of computer systems and networks, including reducing power consumption and network bandwidth usage, by cancellation of hung updates, and so forth.

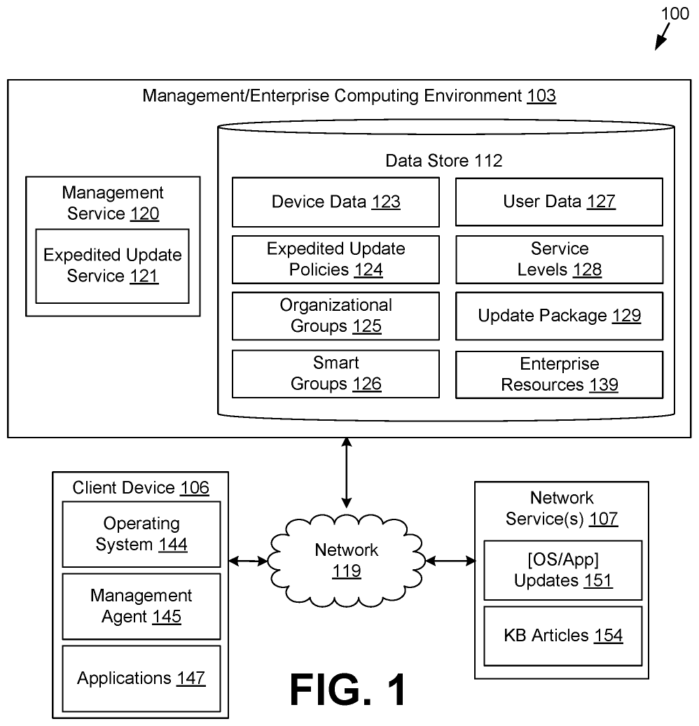

FIG. 1 illustrates an example of a networked environment 100 according to examples of the disclosure. In the depicted networked environment 100, a computing environment 103 is in communication with at least one client device 106 and network services 107 over a network 119. The computing environment 103 can include an environment provided or operated by an entity that also provides the management service 120. The computing environment 103 can additionally or alternatively include devices and components provided or operated by an enterprise that employs the management service 120.

The network 119 includes the Internet, intranets, extranets, wide area networks (WANs), local area networks (LANs), wired networks, wireless networks, other suitable networks, or any combination of two or more such networks. The networks can include satellite networks, cable networks, Ethernet networks, and other types of networks.

The computing environment 103 can be a computing environment that is operated by an enterprise, such as a business or another organization. The computing environment 103 can also include or be described as a management computing environment of a management service that is employed or utilized by an enterprise. The computing environment 103 includes a computing device, such as a server computer that provides computing capabilities. Alternatively, the computing environment 103 can employ multiple computing devices that are arranged in one or more server banks or computer banks. In one example, the computing devices can be located in a single installation. In another example, the computing devices for the computing environment 103 can be distributed among multiple different geographical locations. In one case, the computing environment 103 includes multiple computing devices that together can form a hosted computing resource or a grid computing resource. Additionally, the computing environment 103 can operate as an elastic computing resource where the allotted capacity of computing-related resources, such as processing resources, network resources, and storage resources, can vary over time. In other examples, the computing environment 103 can include or be operated as one or more virtualized computer instances that can be executed to perform the functionality that is described herein.

Various applications or other functionality can be executed in the computing environment 103. Also, various data can be stored in a data store 112 that can be accessible to the computing environment 103. The data store 112 can be representative of a plurality of data stores 112. The data stored in the data store 112 can be associated with the operation of the various applications or functional entities described below.

The components executed on the computing environment 103 can include a management service 120, an expedited update service 121, and other applications, services, processes, systems, engines, or functionality not discussed in detail herein. The management service 120 can be executed in the computing environment 103 to monitor and oversee the operation of one or more client devices 106 by administrators. In some examples, the management service 120 can represent one or more processes or applications executed by an enterprise mobility management (EMM) provider that facilitates administration of client devices 106 of an enterprise that are enrolled with the EMM provider. To this end, the operating system and application ecosystem associated with the client device 106 can provide various APIs and services that allow client devices 106 to be enrolled as managed devices with the management service 120.

The management services 120 can provide EMM services including unified endpoint management (UEM), mobile device management (MDM), endpoint application management, endpoint content management, Identity and Access Management (IAM), security and compliance policy enforcement, virtualization services, and other services. MDM services can manage and secure mobile devices that are used for enterprise productivity. UEM services can manage access to enterprise resources through a broad range of endpoints such as websites, desktops, mobile devices, and virtual devices, among others. Endpoint application management services can include the management of mobile applications on end user and enterprise client devices. Endpoint content management services can include the management of enterprise content accessed using end user and enterprise client devices. Content management services can include data encryption, secure document sharing, and the ability to remotely wipe enterprise data from a device. IAM solutions can be integrated with EMM services to ensure that only authorized users have access to corporate resources, regardless of the device used. It provides authentication and authorization mechanisms for client device users.

The management service 120 can include a management console that can allow administrators to manage client devices 106 that are enrolled with the management service 120. User interfaces can allow an administrator to define policies for a user account or devices associated with an enterprise environment. The user interfaces can also include, for example, presentations of statistics or other information regarding the client devices 106 that can be managed by the management service 120. This can include update statuses associated with the expedited update service 121. The expedited update service 121 can be considered a component of the management service 120, and can work in concert to perform management for an enterprise.

The computing environment 103 can also execute an identity provider or that enables identity and access management. The identity provider can carry out federated user authentication on behalf of an enterprise. For example, the identity provider can implement OAuth, SAML, or similar protocols that allow for federated user authorization or authentication. In examples of this disclosure, the identity provider can also verify a user-and-device token provided by a client device 106 to provide multi-device SSO capabilities as described herein. The identity provider can verify a user's credentials or identity and provide an authentication token, such as a SAML assertion, that can be provided to a network service 107 by an application on a client device 106 to authenticate the user's access to a service provided by the network service 107. The identity provider can issue the authentication token to a client device 106 after verifying the identity of the user and/or client device 106 from which the user is attempting to access the network service 107. In the context of this disclosure, once a user has authenticated his identity from a first device, the identity provider can authenticate the user from a second device that is managed by the management service 120 upon receiving a user-and-device token from the second device, where the user-and-device token can be verified by the identity provider.

The identity provider can verify a user-and-device token issued by the management service 120 to a client device 106 that is enrolled as a managed device and that is associated with a particular user account. The user-and-device token can include information that allows the identity provider to verify the user as well as the device. The user-and-device token can be signed so that the identity provider can verify the authenticity of the token itself. If the user has already established his identity with the identity provider from a first device, and the identity provider subsequently receives a user-and-device token from a second device, the identity provider can establish a SSO session with the second device if the user-and-device token can be validated. Validation can be performed by verifying the signature applied to the user-and-device token as well as the user and device identifying information contained within the token.

In some embodiments, the identity provider can be implemented in a separate computing environment or by a separate entity other than the management service 120. The management service 120 can provide an application programming interface (API) with which the identity provider can communicate to verify a user-and-device token or to obtain a public key with which the signature of a user-and-device token can be verified. The management service 120 can also provide an API through which the identity provider can verify user identifiers or device identifiers that are embedded within a user-and-device token.

The management service 120 and/or identity provider can also receive application usage data from applications or a management component installed on the client device 106. Applications on the client device 106 can report time and date information associated with the application usage. Additionally, cloud-based services can report login and logout information to the management service 120 or identity provider. A SSO client application that operates as a hub to access enterprise applications can be installed on a client device 106 and can report usage of enterprise applications to the management service 120 or identity provider.

The management service 120 or identity provider can also obtain usage of VDI resources associated with a user from a VDI infrastructure environment. A VDI infrastructure environment can utilize the identity provider for identity management and also report usage data to the management service 120 in some instances.

The data stored in the data store 112 can include device data 123, expedited update policies 124, organizational groups 125, smart groups 126, user data 127, service levels 128, enterprise resources 139, and potentially other data. Device data 123 can include records to client devices 106 that are enrolled as managed devices with the management service 120. A record within device data 123 can include various security settings selected for enforcement on a client device 106 that is enrolled with the management service 120. Accordingly, a device record can include a device identifier associated with a device, such as the client device 106 and other data associated with managed devices. In some examples, device data 123 can also identify a user and user data 127 associated with or assigned to a particular client device 106. A device record can also store other device specific information, such as a device type, operating system type or version, applications that are required or optional for the device, or an enrollment status of the device.

Device data 123 can include compliance rules and compliance statuses as well as other information for client devices 106. The compliance rules can include expedited update policies 124. The expedited update policies 124 can specify specific updates 151 and types of updates 151 that must be expedited or installed within a specified time period from publication announcement, or availability of the update 151. The time period can be mapped to a specific update 151 as well as to types, categories, or characteristics of updates 151. In the case an update 151 corresponds to multiple types, categories, or characteristics, then the update 151 can be assigned or mapped to the shortest time period unless otherwise specified by an administrator. The expedited update policies 124 can specify organizational groups 125 and classifications of client devices 106 as well. The classifications can include whether a device is user-owned or enterprise-owned, as well as whether a device is used as a server or host, or as an end user device, a computing architecture of the device, and other classifications.

Certain updates 151 can apply or be limited to certain specified computing architectures such as x86 and other Complex Instruction Set Computer (CISC) architectures, Advanced Micro Devices® (AMD) or other Reduced Instruction Set Computer (RISC) architecture. Certain updates 151 can also apply or be limited to specific software products such as an operating system 144 product and version, or a software application 147 product and version. Example operating system 144 products can include WINDOWS® 10, WINDOWS® 11, or an APPLE® Operating System such as macOS®, as well as mobile operating systems such as ANDROID®, iOS®, and others.

An organizational group 125 can include all devices of an enterprise, or a subset associated with a business unit such as a department, team, or other logical grouping within an enterprise. Users and client devices 106 can be assigned to an organizational group 125. Client devices 106 that are associated with certain users are considered part of the organizational group 125 once enrolled with the management service 120 in association with a particular user or the particular organizational group 125 directly. An update 151 can be assigned to an organizational group 125 for deployment. In some examples, an organizational group 125 can be associated with a smart group 126. The smart group 126 can enable and perform dynamic grouping or classification of devices and users based on certain criteria or attributes. These criteria can include device type, device computing architecture, operating system, product, version, location, ownership, compliance status, installed applications, and other criteria. When an update is applied using a smart group 126, the management service 120 can use the smart group 126 and the device data 123 indicated for each client device 106 to dynamically apply policies, profiles, and security settings to specific sets of client devices 106. The smart group 126 and associated management service instructions can compare the device data 123 to the information indicated in knowledge base articles 154 and update data indicated in an update catalog for the update 151, in order to select a subset of client devices 106 in the smart group 126 and deploy the update. The network services 106 can enable programmatic retrieval of this information using application programming interfaces exposed by the network services 106.

Compliance status of a client device 106 represents whether the device is in compliance with one or more compliance rules. Various compliance rules can be enforced by the management service 120 by the client device 106. Compliance rules can be based on time, geographical location, or device and network properties. For instance, the client device 106 can satisfy a compliance rule when the client device 106 is located within a particular geographic location. The client device 106 can satisfy a compliance rule in other examples when the client device 106 is in communication with a particular local area network, such as a particular local area network that is managed by the computing environment 103. Furthermore, a compliance rule in another example can be based upon the time and date matching specified values.

A compliance rule can specify that a client device 106 is required to be off or in a low power “sleep” state during a specified time period. Another compliance rule can specify that a client device 106 is required to be on or in a normal operation “awake” state during a specified time period. As another example, a compliance rule can specify that a client device 106 is prohibited from rendering content that has been designated as confidential. Another example of a compliance rule involves whether a user belongs to a particular organizational group 125. For instance, a compliance rule can include a whitelist or a blacklist that specifies whether particular users or organizational group 125 are authorized to perform various functionalities, such as installing or executing a particular application 147.

Other examples of compliance rules include a rule that specifies whether a client device 106 is compromised or “jailbroken.” For example, a client device 106 can have hardware or software protections in place that prevent unauthorized modifications of the client device 106. If these protections are overridden or bypassed, the client device 106 can be considered out of compliance. As another example, a compliance rule can specify that the client device 106 is required to prompt a user for a password or personal identification number (PIN) in order to unlock the device.

A compliance rule can also require that the client device 106 be device encryption enabled, where data stored on the device is stored in an encrypted form. The data can be encrypted by a device certificate. A compliance rule can also specify that the client device 106 is enrolled with the management service 120 as a managed device. Another compliance rule can specify that the user is required to accept the terms of service that are presented by the management agent 145 on the client device 106. As another example, a compliance rule can specify that the management agent 145 is required to periodically communicate or “check-in” with the management service 120 to report on its status. If a threshold amount of time has elapsed since the previous check-in of the client device 106, the device can be considered to have violated this compliance rule.

Another compliance rule can specify that a client device 106 be running one of a specified variants or versions of a particular operating system 144 product or software application 147 product. Another compliance rule can specify that a client device 106 must be updated within a period specified in an expedited update policy 124. A compliance rule can also specify that an enrolled device be manufactured by a particular manufacturer or have a particular manufacturer identifier. Another compliance rule can specify that an enrolled device be a particular model name or model number. A client device 106 can also be considered out of compliance if the device is in a data roaming mode or has used a threshold amount of a periodic network data usage allowance.

Accordingly, the compliance statuses indicates whether and to what extent a particular client device 106 is compliant with compliance rules assigned to the client device 106 by the management service 120. The compliance statuses can be determined by a management agent 145 on the client device 106 that analyzes the status of the client device 106 and reports compliance to the management service 120. In other examples, the compliance statuses can be determined by the management service 120 based upon information about the status of the client device 106 that is reported by the management agent 145.

User data 127 contains information about user accounts in a user directory. User accounts can be maintained by a directory service or the identity provider. The user accounts can be associated with client devices 106 that are enrolled with the management service 120. The user data 127 can be associated the same user accounts that are verified by the identity provider. In some implementations, the identity provider can rely upon a separate set of user account data or a user directory to determine whether to issue an authentication token to an application on behalf of the user. In other implementations, the user data 127 is a user directory associated with the identity provider, and the management service 120 accesses the user data 127 through an API provided by the identity provider.

User data 127 can include profile information about a user, authentication information about a user, applications that are installed on client devices 106 associated with the user, and other user information. For example, user data 127 can include information about client devices 106 that are associated with a user account of the user, enterprise resources 139 to which a particular user has access, such as email, calendar data, documents, media, applications, network sites, or other resources. The user data 127 can also identify one or more user groups or organizational groups 125 of which a particular user is a member, which can in turn define the access rights of the user to one or more enterprise resources 139 as well as identify which applications 147, including update applications 129, should be deployed to a client device 106 associated with the user. To this end, the user data 127 can further identify one or more device identifiers that can uniquely identify client devices 106 that are associated with a user account of the user.

The network service 107 can be a computing environment that is operated by an enterprise, such as a business or another organization. The network service 107 includes a computing device, such as a server computer, that provides computing capabilities. Alternatively, the network service 107 can employ multiple computing devices that are arranged in one or more server banks or computer banks. In one example, the computing devices can be located in a single installation. In another example, the computing devices for the network service 107 can be distributed among multiple different geographical locations. In one case, the network service 107 includes multiple computing devices that together can form a hosted computing resource or a grid computing resource. Additionally, the network service 107 can operate as an elastic computing resource where the allotted capacity of computing-related resources, such as processing resources, network resources, and storage resources, can vary over time. In other examples, the network service 107 can include or be operated as one or more virtualized computer instances that can be executed to perform the functionality that is described herein.

The network service 107 can be hosted by a third party and provide various services to users of the enterprise. The services can be considered third-party-hosted or provided enterprise resources 139. As a result, providing access to the enterprise resources 139 can include, for example, providing a VPN tunnel using a tunnel server or providing identity services by the identity provider that provide access to a network service 107. Access to the network service 107 can be federated to the identity provider in some examples. Users can utilize a client device 106, an application 147, or a user interface generated by the network service 107 to access email, calendar, contacts, program services, desktop services, and other resources.

The client device 106 can represent multiple client devices 106 coupled to the network 119 using wired and wireless network connections. The client device 106 includes, for example, a processor-based computer system. According to various examples, a client device 106 can be in the form of a desktop computer, a laptop computer, a personal digital assistant, a mobile phone, a smartphone, or a tablet computer system. The client device 106 can represent a device that is owned or issued by the enterprise to a user, or a device that is owned by the user. The client device 106, when provisioned, can be enrolled with the management service 120 as a managed device of the enterprise.

The client device 106 can execute a management agent 145 or another management component that can communicate with the management service 120 to facilitate management of the client device 106. The management agent 145 can communicate with the management service 120 to enforce management policies, compliance rules, and expedited update policies 124, on the client device 106. For example, the management agent 145 can enforce data security requirements, install, remove or update security certificates, or write, modify, or delete certain data from the client device 106. The management agent 145 can also monitor network activity of the client device 106, the location of the client device 106, enforce password or personal identification number (PIN) requirements, or any other security or acceptable-use policies that are defined in the management service 120 and sent to the management agent 145 over the network 119.

To carry out local management of a client device 106, the management agent 145 can be installed and executed with elevated or administrative privileges in association with the operating system 144 of the client device 106. In some scenarios, the operating system 144 can allow a particular application 147 or package to be identified as a device owner or a device administrator.

One or more applications 147 can be installed on the client device 106. As a managed device that is enrolled with the management service 120, some applications 147 can be installed by the management service 120. In one scenario, the management service 120 can send a request to the management agent 145 to retrieve and install a particular application 147, such as an update package 129, on the client device 106. In this sense, installation of the application 147 is initiated by the management service 120. The management service 120 can also provide configuration data for a particular application 147 that it installed on the client device 106. In the case of an update package 129 to apply an update 151, the management service 120 can utilize a push notification service to push the update to client devices 106. Push notification services can include FIREBASE® Cloud Messaging (FCM), APPLE® Push Notification Service (APNs), WNS (WINDOWS® Notification Service), and others. The push notification service can include a native integration component as part of the operating system 144.

Another example of an application 147 can be an enterprise hub application or SSO application through which a user can authenticate his or her identity and access enterprise applications. Such an application 147 can collect application usage data for applications associated with the enterprise and report the usage data to the management service 120 or the identity provider. In some examples, the management agent 145 can be considered an application 147.

The network services 107 can include services maintained by third parties relative to the management service 120. In the context of operating system 144 and application 147 updates 151, the network services 107 can include services maintained and hosted by a developer of the operating system 144 or application 147, as well as services maintained by third parties to the developer. In some examples, an operating system 144 or an application 147 can include an update service that periodically contacts the network service 107 to check for updates 151. However, in many cases the update service can be delayed such that it can be days or potentially weeks before an update 151 is identified and applied by the developer service. In many examples, this can violate a service level 128 of a service level agreement to be violated. By contrast, the expedited update service 121 can frequently check for updates 151 and KB articles 154, for example, multiple times a day such that updates 151 can be identified and deployed in a manner that overrides the developer-provided update service and complies with the update service level 128.

The service levels 128 can specify the computing services covered by a service level agreement, including hardware and software to be provided, network services, helpdesk support, and other IT-related services. Response and resolution times can also be specified, including update timeframes associated with expedited update policies 124. The expedited update policies 124 can be based on the service levels 128 specified for an enterprise.

The update package 129 can include a software update package generated and deployed to install an update 151. The update package 129 can override an automatic update service provided using the software product itself so that the update can be expedited to meet a service level 128. The update package 129 can include deployment settings to automatically deploy the product update within a specified time from a release date of the product update, based on the service level 128 and the expedited update policies 124. While software-provided update services can periodically check for updates, the period between update checks can be 22 hours, 24 hours, or multiple days. By contrast, the expedited update service 121 can check for updates multiple times a day, such as hourly or another time period specified to be shorter than that of the software-provided update service.

The expedited update service 121 can use the update package 129 to override the software-provided update services and force an update that the software provided update service does not force. Software-provided update services can have an enforcement timeline that forces installation of an update 151. The expedited update service 121 can identify the enforcement timeline in the update data or the article data, and can identify that the enforcement timeline of the software-provided update services does not match a service level 128 for an enterprise. The expedited update service 121 can generate the update package 129 to force the update to be applied within a time period identified based on the service level 128 and the before the enforcement timeline of the software-provided update services.

The update package 129 can hide an installation user interface and automatically perform the update process as a background process according to preconfigured deployment settings. In some examples, the expedited update service 121 can automatically configure the update package 129 by mapping update data and article data to the deployment settings. Additionally or alternatively, the expedited update service 121 can provide a console user interface through which the deployment settings for an update package 129 can be specified and/or approved by an administrative user. The expedited update service 121 can automatically identify an update 151, identify article data in a knowledge base article 154, and generate update applications 129 according to the service levels 128 and expedited update policies 124. In some examples, the expedited update service 121 provide the update package 129 for review, modification, and deployment through the console user interface. The expedited update service 121 can also automatically deploy certain types of updates 151.

An update 151 can refer to a configuration, patch, or other instructions developed by as a modification or update to an operating system 144 or an application 147. In some examples, a developer can provide an automatic update system integrated with the operating system 144 or application 147. The updates 151 can additionally or alternatively be posted in knowledge base articles 154 that provide update information indicating a network location where the update 151 can be downloaded, and additional textual information describing a types, categories, and characteristics of the update 151.

The updates 151 and knowledge base articles 154 can include unique identifiers and friendly names or titles. A knowledge base identifier can refer to a unique reference number assigned to a knowledge base article 154 published to a knowledge base network service 106. The knowledge base network service 106 can be provided by a certain developer or provider company. The knowledge base article 154 can provide information, documentation, and support details for updates 151 to operating systems 144 and applications 147. The knowledge base article 154 can provide information including network locations or addresses for download of an update 151. The knowledge base article 154 can provide details about specific update 151, including release notes, known issues, installation instructions, and troubleshooting guidance. This can include information that indicates whether the update 151 supersedes another update 151.

An update identifier can refer to a unique identifier assigned to a specific update 151 stored in an update catalog network service 106. The update identifier is not typically shown to end-users but is used internally by an update infrastructure or system. The update 151 can also be associated with a friendly name, which can refer to a readable or user friendly description of the update 151. Likewise, knowledge base articles 154 can be associated with a friendly name. In some examples, the knowledge base articles 154 for an update 151 can be associated with the same friendly name, while the unique article identifier can differ from the unique update identifier. In some examples, the knowledge base and the update catalog can be subservices of a single network service 106. In other examples they can be separate network services, regardless of whether they are owned or operated by a single entity or different entities.

The knowledge base article 154 in a knowledge base or another data structure can specify an article title and identifier; a computing architecture; a product name and identifier; an update title and identifier, and a set of additional classification information such as a type, category, or characteristic. The classification information can indicate whether the update is a feature update, security update, quality update, cumulative update, or any combination thereof. A feature update can refer to as version update or another major update that introduces new features, improvements, and changes to a specified product. A security update can refer to a patch that introduces configurations and other changes that protect against security threats such as viruses, viruses, and exploits. A quality updates can refer to a general maintenance update that introduces configurations and other changes for system stability, reliability, and performance. A cumulative update can include an update that has a combination of multiple updates as a single package, and can be tagged or specified to include a superset of the types therein.

The update 151 can be included in an update catalog or another database or data structure of the network service. The update can be stored in association with update data that has significant overlap with information identified in a knowledge base article 154. As a result, the update data can include, for each update 151, one or more associated article title and identifier, a computing architecture, a product name and identifier, an update title and identifier, and the classification information indicating whether the update is a feature update, security update, quality update, cumulative update, or any combination thereof.

In some examples, the information regarding superseding can be specific to an update package 129 additionally or alternatively to information retrieved from a knowledge base article 154. For example, an update package 129 can supersede a previous update package 129 if it has a later time and date, but references the same update 151 or knowledge base article 154. In other cases, the later update package 129 does not supersede unless an administrator has selected a user interface element that indicates that it supersedes a particular update package 129. To this end, the update package 129 can include a universally unique identifier that is different from the other identifiers discussed. However, the update package 129 can additionally or alternatively be identified using a friendly name or title based on a name or title of the knowledge base article 154, or that of the update 151. The friendly name or title of the knowledge base article 154 can be the same or different from its unique identifier, and friendly name or title of the update 151 can be the same or different from its unique identifier.

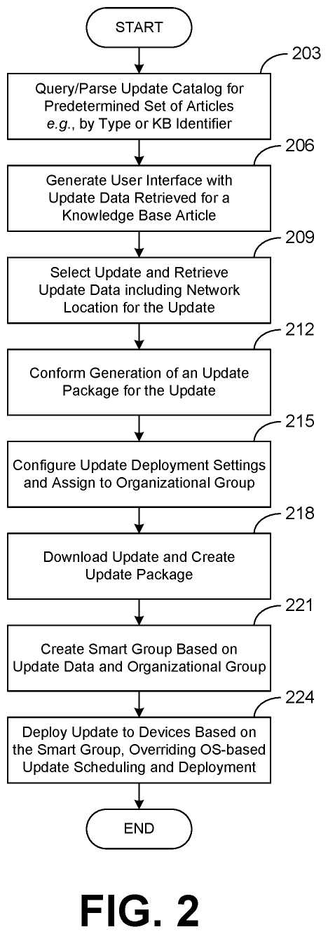

Referring next to FIG. 2, shown is a flowchart that describes how the management service 120 and components of the computing environment 103 work in concert with other components of the networked environment 100 to provide an expedited update framework. While the steps can be generally discussed as performed by a particular component such as the expedited update service 121, certain aspects of the steps can be performed by other components of the computing environment 103.

At step 203, expedited update service 121 can query and parse an update catalog of a network service 107. The network service 107 can refer to a service provided by a developer of an operating system 144 or an application 147 or a third party with respect to the developer and the management service 120. An administrative user can enter or select a knowledge base article 154 by title, identifier, update (article) type, and so on. The user can also type or select a type of update 151, such as a quality update or a feature update, or another categorization of update as indicated by update data for the update 151. This information can be used to select a particular knowledge base article 154. In some examples, the console user interface can show a list of new knowledge base articles 154, a list of update classifications, and so on. The list of update classifications can be used to narrow the list of new knowledge base articles 154.

In order to identify new articles, the expedited update service 121 can periodically query a knowledge base for knowledge base articles 154 that reference an update 151. A reference to an update 151 can include parsing the knowledge base articles 154 to identify for an update identifier format, an update link format such as subnet mask, an update title format, or a keyword indicative of an update 151 to an application 147 or an operating system 144. The expedited update service 121 can identify whether the update 151 is new or already retrieved, stored in the data store 112, and listed in the console user interface. The expedited update service 121 can identify whether the knowledge base article 154 includes features or characteristics that indicate that it is to be expedited, according to the expedited update policies 124 and service levels 128 for a particular enterprise. In some examples, all new knowledge base articles 154 can be automatically listed if they are identified to include a reference to an update 151. If the update 151 referenced in a knowledge base article 154 is to be expedited, then the expedited update service 121 can transmit or surface a notification to a client device 106 or a console user interface of an administrator.

In any case, once a knowledge base article 154 is entered or selected through the console user interface, the expedited update service 121 can query an update catalog for the identifier or title of the knowledge base article 154. The knowledge base article 154 can retrieve a basic or limited subset set of update data so that the administrator can confirm whether to create and deploy an update package 129 for a particular update 151 that references the identifier or name of the knowledge base article 154. While a particular subset of information is indicated, any or all of the update data can be included at this point, in various examples.

At step 206, the expedited update service 121 can update the console user interface to show the update data retrieved from the knowledge base article 154. The update data can include an update title and/or identifier, a computing architecture, a product name and/or identifier, and a set of classification information such as a type, category, or characteristic. In some examples, this can include a single update 151 or multiple updates 151 that reference the knowledge base article 154 or the query. Multiple updates 151 and update identifiers can be retrieved and displayed for selection using a single knowledge base article name or identifier.

At step 209, the expedited update service 121 can select a particular update 151 and retrieve additional update data from the update catalog based on its update identifier. A user can manipulate a user interface element to select a particular update 151 that references the knowledge base article 154 that was previously selected. The expedited update service 121 can query and parse the update catalog to search for the update identifier or friendly name (title) of the selected update 151. The additional update data can include a network location to download the update 151, a severity or importance rating, an article identifier, an article number, a set of supported languages, a size of the update 151, a last modification date of the update 151, a knowledge base article 154 link, a support link, restart behavior, superseding information, and installation information.

In alternative examples, the expedited update service 121 can start the process by providing a list of new updates 151 in the console, and the administrator can use the information provided to decide whether to generate and deploy an update package 129 for the update 151. In order to identify new updates 151, the expedited update service 121 can periodically query the update catalog for new updates 151. The expedited update service 121 can identify whether the update 151 is new or already retrieved, stored in the data store 112, and listed in the console user interface. The update 151 can reference knowledge base articles 154 based on identifier, title, network location, and other information. The expedited update service 121 can identify whether the update data, and the referenced knowledge base article 154, includes features or characteristics that indicate that it is to be expedited, according to the expedited update policies 124 and service levels 128 for a particular enterprise. In some examples, all new updates 151 can be automatically listed. If the update 151 is to be expedited, then the expedited update service 121 can transmit or surface a notification to a client device 106 or a console user interface of an administrator. A user can manipulate a user interface element to select a particular update 151.

At step 212, the expedited update service 121 can confirm that an update package 129 is to be generated for a selected update 151. The console user interface can be updated to include update data including the previous set of information, but additionally including a network location to download the update 151, a severity or importance rating, an article identifier, an article number, a set of supported languages, a size of the update 151, a last modification date of the update 151, a knowledge base article 154 link, a support link, restart behavior, superseding information, and installation information. Installation information can include whether user input is used, whether network connectivity is required during the installation, installation instructions, and uninstallation instructions. Restart behavior can include whether a restart is required, a number of restarts required, and so on. The superseding information can refer to a list of updates 151 that the selected update 151 replaces, includes, or supersedes. The administrator can review this information and select a user interface element to confirm that the update package 129 is to be generated for the selected update 151.

At step 215, the expedited update service 121 can update the console user interface to include elements that configure update deployment settings for the update 151. This can include assignment of the update package 129 to an organizational group 125. The update deployment settings user interface can enable an administrator to assign the update package 129 to all or a subset of client devices 106 by selecting one or more organizational groups 125 or a pre-existing smart group 126. The smart group 126 can be associated with one or more organizational groups 125, or another set of client devices 106 managed by the management service 120 for the enterprise. The expedited update service 121 can automatically configure the update package 129 to comply with the expedited update policies 124, service levels 128, and default settings specific to the enterprise. However, the expedited update service 121 can also enable the administrative user to alter or change any of the automatically preconfigured settings.

The deployment settings can indicate whether the deployment is required; a deployment timeframe and whether the deployment should proceed immediately or during a specified window; whether to use wake-on-LAN to wake up client devices 106 to meet a deployment deadline. The deployment settings can indicate a level of detail for status information client devices 106 are to return for the deployment-such as limiting status information to success or failure. The deployment settings can include a user experience configuration such as whether notifications are to be shown to the user of a client device 106.

Deployment settings can indicate a type of device that is included or excluded for the update package 120, such as server devices, end user devices, workstation devices, mobile devices, desktop devices, kiosk devices, shared device, enterprise-owned device, user-owned device, or another device type specified in the update package 129 configuration. In some examples specifying the device type can include specification by excluding certain device types from the update package 129 and including all that are unexcluded. A single device can correspond to multiple device types.

The deployment settings can include a set of actions to perform such as forcing install and/or restart once a deployment deadline is reached or is within a threshold amount of time. The deployment settings can indicate whether to suppress system restart for certain categories of devices such as servers and/or workstations. The deployment settings can include a set of triggers that can generate an administrative alert, such as client compliance under a predetermined percentage of client devices 106 at a predetermined time. The deployment settings can indicate whether to download and install the update package 129 if the client device 106 has slow or unreliable network. The deployment settings can include a default hosting network location in the computing environment 103.

The deployment settings can include a fallback network hosting location in the computing environment 103 to download the update package 129 if the default hosting location fails. The deployment settings can also indicate to enable peer-to-peer downloads where at least a portion of the update package is downloaded using a peer-to-peer network among the client devices 106 that are also downloading the update package 129. This can prevent overloading a hosting location in the context of the updates that must be deployed ahead of the standard update deployment schedule, since many devices can be downloading the same update package 129 in a constrained time period. The deployment settings can indicate whether to enable or force downloading the update from the network service 109 if the default and fallback network locations within the computing environment 103 fail. The deployment settings can include setting an update package 129 name, which can match the title or friendly name of the update 151 by default. The deployment settings can include configurations for one or more supported language choices to include.

The deployment settings can indicate whether to expedite installation for a specific subset of client devices 106 such as those with an operating system 144 or application 147 version that is earlier or older than a specified version or a specified date. The deployment settings can indicate a number of hours or days to wait before a restart is enforced to initiate or complete installation of the update package 129. In some instances, the name of the update package 129 can be the same as or based on the update title from the update data, the restart configuration can be set based on the restart behavior indicated in the update data, and a detection method can be included or specified in the update package 129 to make sure that the update is installed and matches a hash, a file size, and other information.

At step 218, the expedited update service 121 can download the update 151 from the network service 109 and create the update package 129 to deploy the update 151. The expedited update service 121 can generate the update package 129 so that it can automatically install the update 151 without user interactions, even if the update 151 includes user prompts. For example, the update package 129 can hide, override, or omit the update 151 installation user interface on the client device 106, and can provide automated inputs that simulate user selections, thereby smoothing the installation process. The expedited update service 121 can store the update 151 and the update package 129 in the data store 112 of the computing environment 103. This can include a master copy that is not used as a download location, as well as making the update package 129 available using a content distribution network provided by the computing environment 103 and the management service 120.

In some examples, the expedited update service 121 can upload the update 151 to a device server maintained by the management service 120 by invoking a programmatic application programming interface or another programmatic interface exposed by the device server. The device server can create the update package 129 using the update 151 file and the deployment settings, where the deployment settings and the update 151 are provided as parameters for the programmatic interface. In other examples, the deployment settings are automatically generated by providing the update data and article data associated with the update 151 as parameters for the programmatic interface. In any case, the management service 120 can generate deployment settings based on the update data and article data, and can further enable administrative modifications to the default deployment settings.

At step 221, the expedited update service 121 can create a smart group 126 based on the update data for the update 151, any specified organizational groups 125, and the other configurations specified in the update package 129 configurations. Alternatively, the expedited update service 120 can automatically select a preexisting smart group 126 based on this information. In further examples, a user can select a preexisting smart group 126 rather than specifying an organizational group 125 or other standard grouping of devices. The subset of client devices 106 can refer to those that match the update data indicated in the update catalog and the article data in the associated knowledge base articles 154. For example, the subset of client devices 106 that include the product, correspond to the computing architecture specified, and match a type of device specified. When the smart group 126 is created for the update package 129 rather than being a pre-existing group, the smart group 126 can have a name that matches the update title and the update package name. The expedited update service 121 can assign the update package 129 to the smart group 126 for the update 151.

At step 224, the expedited update service 121 can deploy the update package 129 using the smart group 126. The smart group 126 and associated management service instructions can compare the device data 123 to the information indicated in knowledge base articles 154 and update data indicated in an update catalog for the update 151, in order to select, from the smart group 126, a subset of client devices 106 for deployment of the update package 129. Generally, this includes transmitting a push notification to a set of client devices 106 corresponding the smart group 126, transmitting installation commands once a respective client device 106 checks in, receiving an installation status from a respective client device 106, and generating a console user interface that reports individual device and overall deployment completion across all client devices 106 of the smart group 126. The management agents 145 or the update package 129 itself can be executed using a client device 106 to enable peer-to-peer connections such that a portion of the client devices 106 that have downloaded at least a portion of the update package 129 can create and provide a peer-to-peer network for other ones of the client devices 106 to download the update package 129.

The update package 129 can override automatic operating system 144 or application 147 based updating services that are provided by a developer of these products, and can ensure installation before a service level 128 rather than operating on a developer-specified timeline. In some cases, this includes installation and verification that is specified to be less than an update schedule time period of the developer provided automatic update service. For example, some update services can check for updates once a day, every 22 hours, or another period of time. However, the update package 129 can provide an update timeline that matches a service level 128, even in an instance in which the automatic update service may not have checked for an update or begun an installation process. In some examples, when the expedited update service 121 is enabled for an enterprise or a set of client devices 106, the management service 120 can transmit a command for the management agent 145 to disable the automatic update services of the operating system 144 and applications 147 for those devices. In any case, installation of the update package 129 can obviate and prevent installation of the update 151 using an automatic update service provided by a developer of the updated operating system 144 or application 147.

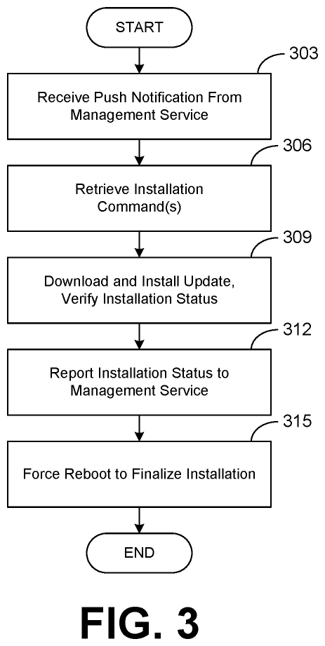

Referring next to FIG. 3, shown is a flowchart that describes how the management agent 145, operating system 144, and other components of the client device 106 work in concert with components of the networked environment 100 to provide an expedited update framework. While the steps can be generally discussed as performed by a particular component such as the management agent 145, certain aspects of the steps can be performed by other components of the computing environment 103.

At step 303, the management agent 145 of a client device 106 can receive a push notification from the management service 103. The management service 120 can create a smart group 126 specifically for deployment of an update package 129. The client device 106 can be added to the smart group 126. This can cause an update to the device object or account in the device data 123. The update to the device object can trigger the management service 120 to send a push notification to the client device 106. The management agent 145 can identify the push notification and can check in with the management service 120. In some examples, the push notification can be provided using the operating system 144. However, other push notification systems can be used.

At step 306, the management agent 145 can retrieve an installation command from a command queue or another endpoint of the management service 120. The management service 120 can place the installation command in the command queue for the client device 106. The installation command can include installation instructions and a network location to download the update package 129.

At step 309, the management agent 145 can download and install the update package 129 according to the installation command. The update package 129 or the management agent 145 can track and monitor the installation of the update package 129 according to reporting instructions indicated in the deployment settings of the update package 129. The update package 129 or the management agent 145 can also verify whether the installation is successfully completed. In an instance in which the update package performs this functionality, the resulting installation status can be provided to the management agent 145. The management agent 145 or the update package 129 itself can enable peer-to-peer connections such that a portion of the client devices 106 that have downloaded at least a portion of the update package 129 can create and provide a peer-to-peer network for other ones of the client devices 106 to download the update package 129.

At step 312, the management agent 145 report an installation status to the management service 120. The installation status can include information such as success or failure of the installation. In some examples, the deployment settings can require updates during the installation, or additional information about the installation process such as a duration of the installation, an amount of system resources utilized by the installation process or update package 129, a set of applications 147 installed and/or running during installation, and other hardware and software configurations of the client device 106 at the time of installation.

In step 315, the management agent 145 can force a reboot to finalize the installation, if required according to the deployment configuration of the update package 129. However, if no restart is required according to update data and knowledge base articles 154 for the update 151, then the reboot is not likely to be forced. In some examples, the deployment configuration can indicate to wait a predetermined amount of time after installation, or to wait until a predetermined time before a deployment deadline in order to force a reboot of the client device 106. This can enable a user-initiated reboot or shutdown to be used rather than a forced reboot. If a user-initiated reboot occurs, the management agent 145 can cancel the forced reboot. However, if a user-initiated is unidentified within a predetermined time before a deployment deadline, the management agent 145 or the update package 129 can perform a forced reboot.

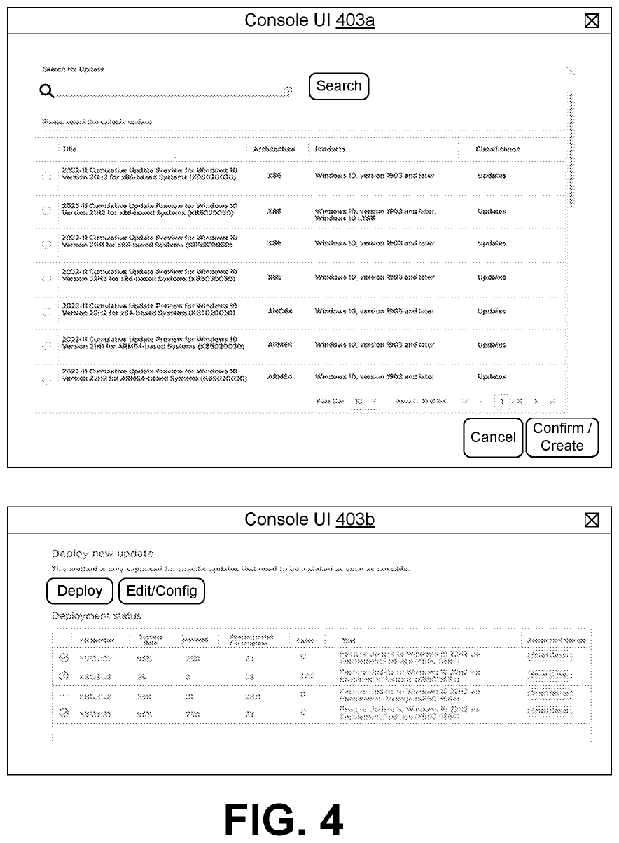

FIG. 4 is a drawing that illustrates examples of console user interfaces 403a and 403b generated by the management service 120 or the expedited update service 121. The console user interfaces 403a and 403b can provide an example of how the expedited update service 121 can enable an administrator to efficiently identify updates 151, generate update packages 129, and deploy update packages 129 to provide an expedited and service level compliant update framework.

The console user interface 403a can show a search user interface with a search bar and a list of updates 151 that can be selected for inclusion in an update package 129. In various examples, the list shown can be a list of all new updates 151 in an update catalog, updates 151 from the update catalog that are associated with a knowledge base article 154, a list that conforms to another query such as a character string entered into the search bar, or a list that conforms to a selection of update data or article information in another console user interface.

The console user interface 403a can include, for each update 151 listed, a selection user interface element. The console user interface 403a can include, for each update 151 listed, information including a title, an architecture, an indication of products applicable to the update 151, a classification. In some cases, additional update data and knowledge base article data can be provided as described.

The console user interface 403a can include a user interface element that enables a user to confirm the selections and initiate creation of an update package 129. Selection of the confirmation or creation user interface element can update the user interface to include a deployment settings wizard or process that includes configurations of deployment settings identified based on the update data and knowledge base article data for an update 151. The deployment settings user interface can also a set of user interface elements that enable user modification of the deployment settings. The wizard can ensure that all user inputs required by an update 151 are preconfigured as deployment settings and surfaced to the administrative user.

The console user interface 403b can show a deployment status user interface for an update package 129. The deployment status can include a table or other structure that shows, for each update package 129, an associated knowledge base article identifier, an overall success rate, a number of client devices 106 that have installed the update package 129, a number of client devices 106 that are pending or in progress with the installation of the update package 129, a number of client devices 106 that have failed the installation, a name or title of the update package 129, and a set of one or more groups or smart groups 126 that are set to install the update package 129.

The update package 129 can also be shown in association with an icon that indicates whether the deployment is on track for completion based on the service levels 128 and the installation status information received and/or indicated in the table. A user selection of the icon and subsequent selection of the edit and configuration user interface element can update the console user interface 403b to show user interface elements to update the deployment settings. A user selection of a ‘smart group’ user interface element can update the user interface 403b to show a list of devices 106 in the smart group 126. This can also enable administrative editing such as adding or removing specific devices and categories or types of devices from the smart group 126.

While flowcharts and sequence diagrams can show an example of the functionality and operation herein can be embodied in hardware, software, or a combination of hardware and software. If embodied in software, each element can represent a module of code or a portion of code that includes program instructions to implement the specified logical function(s). The program instructions can be embodied in the form of source code that includes human-readable statements written in a programming language or machine code that includes machine instructions recognizable by a suitable execution system, such as a processor in a computer system or another system. If embodied in hardware, each element can represent a circuit or a number of interconnected circuits that implement the specified logical function(s).

Although flowcharts and sequence diagrams can show a specific order of execution, it is understood that the order of execution can differ from that which is shown. The order of execution of two or more elements can be switched relative to the order shown. Also, two or more elements shown in succession can be executed concurrently or with partial concurrence. Further, in some examples, one or more of the elements shown in the flowcharts can be skipped or omitted. In addition, any number of counters, state variables, warning semaphores, or messages could be added to the logical flow described herein, for purposes of enhanced utility, accounting, performance measurement, or troubleshooting aid. It is understood that all such variations are within the scope of the present disclosure.

The client device 106, or other components described herein, can each include at least one processing circuit. The processing circuit can include one or more processors and one or more storage devices that are coupled to a local interface. The local interface can include a data bus with an accompanying address/control bus or any other suitable bus structure. The one or more storage devices for a processing circuit can store data or components that are executable by the one or processors of the processing circuit. Also, a data store can be stored in the one or more storage devices.

The management service 120, identity provider, management agent 145, applications 147, and other components described herein can be embodied in the form of hardware, as software components that are executable by hardware, or as a combination of software and hardware. If embodied as hardware, the components described herein can be implemented as a circuit or state machine that employs any suitable hardware technology. The hardware technology can include one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that includes software or program instructions can be embodied in any non-transitory computer-readable medium for use by or in connection with an instruction execution system such as a processor in a computer system or other system. The computer-readable medium can contain, store, or maintain the software or program instructions for use by or in connection with the instruction execution system.

The computer-readable medium can include physical media, such as, magnetic, optical, semiconductor, or other suitable media. Examples of a suitable computer-readable media include, but are not limited to, solid-state drives, magnetic drives, flash memory. Further, any logic or component described herein can be implemented and structured in a variety of ways. One or more components described can be implemented as modules or components of a single application. Further, one or more components described herein can be executed in one computing device or by using multiple computing devices.

It is emphasized that the above-described examples of the present disclosure are merely examples of implementations to set forth for a clear understanding of the principles of the disclosure. While aspects of the disclosure are discussed with respect to a particular figure, the aspects can be applied in combination with the other figures. Many variations and modifications can be made to the above-described examples without departing substantially from the spirit and principles of the disclosure. All of these modifications and variations are intended to be included herein within the scope of this disclosure.

Therefore, the following is claimed:

1. A system comprising:
at least one computing device;
at least one application executed by the at least one computing device, wherein the at least one application causes the at least one computing device to at least:
identify, by a management service, an article identifier or a knowledge base article provided by a knowledge base network service, wherein the knowledge base article references a software product;
retrieve, based at least in part on the article identifier, update data for a product update provided by an update catalog network service, wherein the product update modifies the software product;
generate, by the management service, an update package comprising deployment settings to automatically deploy the product update within a specified time from a release date of the product update;
identify a smart group that enables dynamic selection a subset of a plurality of client devices; and
deploy the update package to the subset of the plurality of client devices dynamically selected using the smart group, wherein the subset of the plurality of client devices are identified to correspond to the update data for the product update based at least in part on attributes of respective ones of the client devices.

2. The system of claim 1, wherein the software product comprises an operating system or an application.

3. The system of claim 1, wherein the specified time is identified to be in compliance with a service level.

4. The system of claim 1, wherein the update package is deployed by generating and storing a command to install the update package, and transmitting a push notification to the subset of the predetermined group of client devices, wherein the push notification cause the subset of the predetermined group of client devices to retrieve the command to install the update package.

5. The system of claim 1, wherein the deployment settings perform a forced restart within the specified time in an instance in which a user-initiated restart is unidentified at a predetermined point prior to an end of the specified time.

6. The system of claim 1, wherein the knowledge base network service is provided by a developer of the software product.

7. The system of claim 1, wherein the instructions, when executed by at least one processor, cause at least one computing device to at least:
create, by the management service, an update-specific smart group comprising a title of the product update from the update data.

8. A non-transitory computer-readable medium comprising machine-readable instructions, wherein the instructions, when executed by at least one processor, cause at least one computing device to at least:
identify, by a management service, an article identifier or a knowledge base article provided by a knowledge base network service, wherein the knowledge base article references a software product;
retrieve, based at least in part on the article identifier, update data for a product update provided by an update catalog network service, wherein the product update modifies the software product;
generate, by the management service, an update package comprising deployment settings to automatically deploy the product update within a specified time from a release date of the product update;
identify a smart group that enables dynamic selection a subset of a plurality of client devices; and
deploy the update package to the subset of the plurality of client devices dynamically selected using the smart group.

9. The non-transitory computer-readable medium of claim 8, wherein the subset of the plurality of client devices are identified to correspond to the update data for the product update based at least in part on attributes of respective ones of the client devices.

10. The non-transitory computer-readable medium of claim 8, wherein the specified time is identified to be in compliance with a service level.

11. The non-transitory computer-readable medium of claim 8, wherein the update package is deployed by generating and storing a command to install the update package, and transmitting a push notification to the subset of the predetermined group of client devices, wherein the push notification cause the subset of the predetermined group of client devices to retrieve the command to install the update package

12. The non-transitory computer-readable medium of claim 8, wherein the deployment settings perform a forced restart within the specified time in an instance in which a user-initiated restart is unidentified at a predetermined point prior to an end of the specified time.

13. The non-transitory computer-readable medium of claim 8, wherein the knowledge base network service is provided by a third party relative to a developer of the software product.

14. The non-transitory computer-readable medium of claim 8, wherein the update data indicates the release date.

15. A method performed using instructions executed by at least one computing device, the method comprising:
retrieving, by a management service, update data for a product update provided by an update catalog network service, wherein the product update modifies the software product;
generating, by the management service, an update package comprising deployment settings to automatically deploy the product update within a specified time from a release date of the product update;
identifying a smart group that enables dynamic selection a subset of a plurality of client devices; and
deploying the update package to the subset of the plurality of client devices dynamically selected using the smart group.

16. The method of claim 15, wherein the subset of the plurality of client devices are identified to correspond to the update data for the product update based at least in part on attributes of respective ones of the client devices.

17. The method of claim 15, wherein the specified time is identified to be in compliance with a service level.

18. The method of claim 15, wherein the update package is deployed by generating and storing a command to install the update package, and transmitting a push notification to the subset of the predetermined group of client devices, wherein the push notification cause the subset of the predetermined group of client devices to retrieve the command to install the update package

19. The method of claim 15, wherein the deployment settings specify to perform a forced restart within the specified time in an instance in which a user-initiated restart is unidentified at a predetermined point prior to an end of the specified time.

20. The method of claim 19, wherein at least one of the update package or a client side management agent perform the forced restart.
